(19) United States
(12) Patent Application Publication
(10) Pub. No.: US 2026/0188185 A1
(43) Pub. Date: Jul. 2, 2026

(54) DISPLAY APPARATUS AND DRIVING POWER CONTROL METHOD THEREOF

(71) Applicant: LG Display Co., Ltd., Seoul (KR)

(72) Inventors: Yong Ho KIM, Paju-si (KR); Jae Yi CHOI, Paju-si (KR)

(73) Assignee: LG Display Co., Ltd., Seoul (KR)

(21) Appl. No.: 19/245,945

(22) Filed: Jun. 23, 2025

(30) Foreign Application Priority Data
Dec. 26, 2024 (KR) 10-2024-0197367

(51) Int. Cl. G09G 3/32

(52) U.S. Cl. CPC G09G 3/32; G09G 2310/0267; G09G 2310/0286; G09G 2310/0289; G09G 2320/041; G09G 2320/043; G09G 2330/021

(57) ABSTRACT

A display apparatus includes a display panel, a gate driver configured to receive a high-level variable voltage and a carry clock for an operation of each stage to drive gate lines of the display panel, and a driving power control circuit configured to control an on-clock voltage of the carry clock and the high-level variable voltage configured to be applied to a QB node of each stage, wherein the high-level variable voltage and the on clock voltage of the carry clock are configured to be up-shifted as a driving time elapses.

### CROSS-REFERENCE TO RELATED APPLICATION

This application claims the benefit of Korean Patent Application No. 10-2024-0197367, filed on Dec. 26, 2024, which is hereby incorporated by reference as if fully set forth herein.

### BACKGROUND

### Field

The present disclosure relates to a display apparatus and a driving power control method thereof.

### Discussion of the Related Art

Display apparatuses include a display panel and a gate driver for driving gate lines of the display panel. The gate driver may be provided in a non-display area of the display panel through a thin film transistor (TFT) process so as to decrease the manufacturing cost.

Gate drivers need a driving power for a normal operation. The driving power is set to an initial voltage when releasing products. When the initial voltage of the driving power is set to be high, the reliability and lifetime of gate drivers may be reduced. Also, when an initial threshold voltage (Vth) of a TFT formed in gate drivers is (−) shifted, a possibility that an abnormal image occurs is high, and due to this, the initial operation reliability of gate drivers may be reduced.

### SUMMARY

Accordingly, the present disclosure is directed to a display apparatus and a driving power control method thereof that substantially obviate one or more problems due to limitations and disadvantages of the related art.

To overcome the aforementioned problem of the related art, the present disclosure may provide a display apparatus and a driving power control method thereof, which may increase the operation reliability of a gate driver.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a display apparatus includes: a display panel; a gate driver configured to receive a high-level variable voltage and a carry clock for an operation of each stage to drive gate lines of the display panel; and a driving power control circuit configured to control an on-clock voltage of the carry clock and the high-level variable voltage configured to be applied to a QB node of each stage, wherein the high-level variable voltage and the on clock voltage of the carry clock are configured to be up-shifted as a driving time elapses.

It is to be understood that both the foregoing general description and the following detailed description of the present disclosure are by way of example and are intended to provide further explanation of the disclosures as claimed.

### BRIEF DESCRIPTION OF THE DRAWINGS

The accompanying drawings, which are included to provide a further understanding of the present disclosure and are incorporated in and constitute a part of this application, illustrate example embodiment(s) of the disclosure and together with the description serve to explain various principles of the disclosure. In the drawings:

FIG. 1 is a block diagram illustrating a display apparatus according to an example embodiment;

FIG. 2 is a diagram schematically illustrating a stage connection configuration of a gate driver according to an example embodiment;

FIG. 3 is a diagram illustrating a circuit configuration of a stage included in a gate driver according to an example embodiment;

FIG. 4 is a diagram illustrating a circuit configuration of a dummy stage included in a gate driver according to an example embodiment;

FIG. 5 is a diagram illustrating an abnormal behavior of Vclamp with respect to a threshold voltage shift characteristic of transistors included in a stage;

FIG. 6 is a diagram illustrating a driving power control circuit according to an example embodiment;

FIG. 7 is a diagram illustrating an output of a driving power control circuit according to an example embodiment;

FIG. 8 is a diagram illustrating an example where an on-clock voltage of a carry clock is up-shifted as a driving time elapses, within a voltage range which is lower than a gate high voltage;

FIG. 9 is a diagram illustrating a driving power control circuit according to another example embodiment;

FIG. 10 is a diagram illustrating an output of a driving power control circuit according to another example embodiment;

FIG. 11 is a diagram illustrating an example where an on-clock voltage of a carry clock is set to be lower in a low temperature environment of initial driving than a high temperature environment after a driving time elapses, and thus, a ripple magnitude of a Q node voltage is reduced; and

FIG. 12 is a diagram illustrating an effect where an on-clock voltage of a carry clock is set to be low even when a threshold voltage is shifted in initial driving, and thus, an abnormal behavior of Vclamp is prevented or reduced.

### DETAILED DESCRIPTION

Hereinafter, the present disclosure will be described more fully with reference to the accompanying drawings, in which example embodiments of the disclosure are shown. The disclosure may, however, be embodied in many different forms and should not be construed as being limited to the embodiments set forth herein; rather, these example embodiments are provided so that this disclosure will be thorough and complete, and will fully convey the concept of the disclosure to those skilled in the art.

Advantages and features of the present disclosure, and implementation methods thereof, will be clarified through following example embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Furthermore, the protected scope of the present disclosure is only defined by scopes of claims and their equivalents.

The shapes, sizes, ratios, angles, numbers and the like disclosed in the drawings for description of various embodiments of the present disclosure to describe embodiments of the present disclosure are merely examples, and the present disclosure is not limited thereto. Like reference numerals refer to like elements throughout. Throughout this specification, the same elements are denoted by the same reference numerals. As used herein, the terms “comprise”, “having,” “including” and the like suggest that other parts can be added unless a more limiting term like “only” is used. As used herein, the singular forms “a”, “an”, and “the” are intended to include the plural forms as well, unless context clearly indicates otherwise.

Elements in various embodiments of the present disclosure are to be interpreted as including margins of error even without explicit statements.

In describing a position relationship, for example, when a position relation between two parts is described as “on˜”, “over˜”, “under˜”, and “next˜”, one or more other parts may be disposed between the two parts unless a more limiting term like “just” or “direct” is used.

It will be understood that, although the terms “first”, “second”, etc. may be used herein to describe various elements, these elements should not be limited by these terms. These terms are only used to refer to one element separately from another. For example, a first element could be termed a second element, and, similarly, a second element could be termed a first element, without departing from the scope of the present disclosure.

Hereinafter, example embodiments of the present disclosure will be described in detail with reference to the accompanying drawings. In descriptions below, where detailed descriptions of elements or technology relevant to the present disclosure may unnecessarily obscure features of the present disclosure, its detailed description may be omitted.

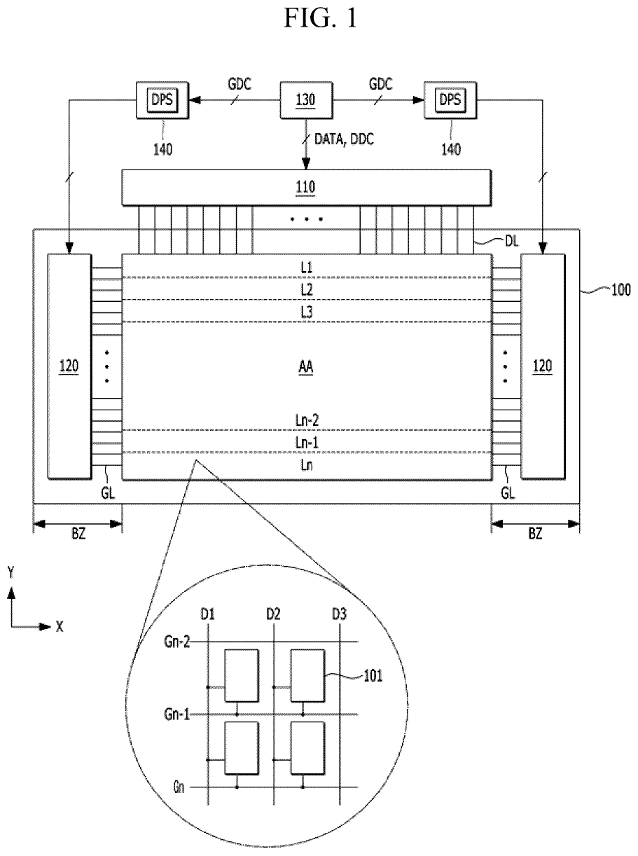

FIG. 1 is a block diagram illustrating a display apparatus 100 according to an example embodiment of the present disclosure.

As shown in FIG. 1, the display panel 100 may include a screen AA which reproduces an input image. The screen AA may include a pixel array which displays pixel data (hereinafter referred to as “image data”) DATA of an input image. The pixel array may include a plurality of data lines DL, a plurality of gate lines GL intersecting with the data lines DL, and a plurality of pixels 101.

The pixels 101 may be arranged on the screen AA in a matrix type defined by intersections between the data lines DL and the gate lines GL. The pixels may be arranged as various types such as a stripe type, a diamond type, and a type which shapes pixels emitting lights of the same color, in addition to a matrix type, on the screen AA.

The pixel array may include a plurality of pixel columns and a plurality of pixel rows L1 to Ln intersecting with the pixel columns. Each of the pixel columns may include pixels which are arranged in a y-axis direction. A pixel row may include pixels which are arranged in an x-axis direction. One vertical period may be one frame period for charging image data DATA of one frame in all pixels of the screen. One horizontal period may be a time obtained by dividing one frame period by the number of pixel rows L1 to Ln. One horizontal period may be a time for charging the image data DATA of one pixel row, sharing a gate line GL, in pixels of one pixel row.

Each of the pixels 101 may include a red (R) pixel 101, a green (G) pixel 101, and a blue (B) pixel 101 for color implementation. Each of the pixels 101 may further include a white (W) pixel 101.

Each of the pixel 101 may include a driving element which generates a driving current corresponding to a gray level of the image data DATA and a light emitting device where the amount of emitted light is controlled based on a magnitude of the driving current. The R pixel may include a red light emitting device, the G pixel may include a green light emitting device, the B pixel may include a blue light emitting device, and the W pixel may include a white light emitting device.

The plurality of pixels 101 may configure one unit pixel for various color implementations. For example, four R, G, B, and W pixels arranged adjacent to one another in an extension direction of the gate line GL or an extension direction of the data line DL may configure one unit pixel.

In FIG. 1, “D1 to D3” may be data lines, and “Gn-2 to Gn” may be gate lines. Also, each of the pixels 101 of FIG. 1 may include the same pixel circuit. The pixel circuit may include a driving element, one or more switch elements, and one or more capacitors.

Touch sensors may be disposed on the display panel 100. The touch sensors may be arranged as an on-cell or add-on type on the screen AA of the display panel 100, or may be implemented as in-cell type touch sensors embedded in the pixel array. A touch input may be sensed through the touch sensors, or may be sensed through only the pixels 101 even without touch sensors.

A display panel driver may include a source driver 110 and a gate driver 120. The display panel driver may write image data DATA in the pixels 101 of the display panel 100, based on control by the timing controller 130.

The source driver 110 may convert the image data DATA, received from the timing controller 130, into gamma voltages by using a digital-to-analog converter (DAC) to generate data voltages. The source driver 110 may supply the data voltages to the data lines DL. The data voltages may be supplied to the data lines DL and may be applied to the driving elements through switch elements of the pixels 101. The source driver 110 may be implemented with one or more source drive integrated circuits. The source drive integrated circuit may further include an external compensation sensing circuit for sensing a driving characteristic of the driving element and/or the light emitting device of each pixel 101. Each of the source drive integrated circuits may further include a touch driver which generates a touch sensor driving signal and converts an electric charge variation of a touch sensor into touch raw data.

The gate driver 120 may be provided in a bezel region BZ which is outside a screen and does not display an image on the display panel 100. The gate driver 120 may sequentially supply a gate signal, synchronized with data voltages, to the gate lines GL according to control by the timing controller 130. The gate signal may simultaneously activate pixel lines Ln-2 to Ln where the data voltages are charged. The gate driver 120 may include a plurality of gate stages and may output the gate signal and may shift the gate signal, based on a progressive or non-progressive scheme. The gate signal may include one or more scan signals and an emission control signal.

The timing controller 130 may receive video data DATA and a timing signal, synchronized with the video data DATA, from the host system (not shown). The timing signal may include a vertical synchronization signal Vsync, a horizontal synchronization signal Hsync, a clock signal DCLK, and a data enable signal DE. The vertical synchronization signal Vsync may define a vertical period (i.e., one frame period). The horizontal synchronization signal Hsync may define a horizontal period. The data enable signal DE may define a time for which the image data DATA is transferred in the vertical period or the horizontal period. The vertical period and the horizontal period may be known based on a method of counting the data enable signal DE, and thus, the vertical synchronization signal Vsync and the horizontal synchronization signal Hsync may be omitted.

The timing controller 130 may generate a source timing control signal DDC for controlling an operation timing of the source driver 110 and a gate timing control signal GDC for controlling an operation timing of the gate driver 120, based on the timing signal Vsync, Hsync, and DE received from the host system.

The timing controller 130 may multiply an input frame frequency by i (where i may be a natural number) times to control an operation timing of the display panel driver 110 and 120, based on a frame frequency of an input frame frequency×i Hz. The input frame frequency may be about 60 Hz in national television standards committee (NTSC) scheme and may be about 50 Hz in phase-alternating line (PAL) scheme.

The host system may be one of a television (TV) system, a set-top box, a navigation system, a personal computer (PC), a home theater system, an automotive display system, a mobile device, and a wearable device. In mobile devices and wearable devices, the source driver 110, the timing controller 130, and the level shifter 140 may be integrated into one drive integrated circuit (IC).

The level shifter 140 may respectively level-shift a logic on voltage and a logic off voltage of the gate timing control signal GDC, output from the timing controller 130, to a gate high voltage and a gate off voltage and may supply the gate high voltage and the gate off voltage to the gate driver 120. The gate high voltage and the gate off voltage may be direct current (DC) voltages of a fixed level.

The level shifter 140 may include a driving power control circuit DPS. The driving power control circuit DPS may control an on-clock voltage of a carry clock and a high-level variable voltage to be supplied to a QB node of each stage and may supply the controlled voltages to the gate driver 120. The high-level variable voltage and the clock voltage of the carry clock may be alternating current (AC) voltages which are up-shifted as a driving time elapses. The high-level variable voltage and the clock voltage of the carry clock may vary within a voltage range which is lower than the gate high voltage which is an on-clock voltage of a scan clock.

The timing controller 130 may transfer the image data DATA to the source driver 110 through an internal interface circuit. The first interface circuit may be implemented as an embedded clock point to point interface (EPI), but is not limited thereto.

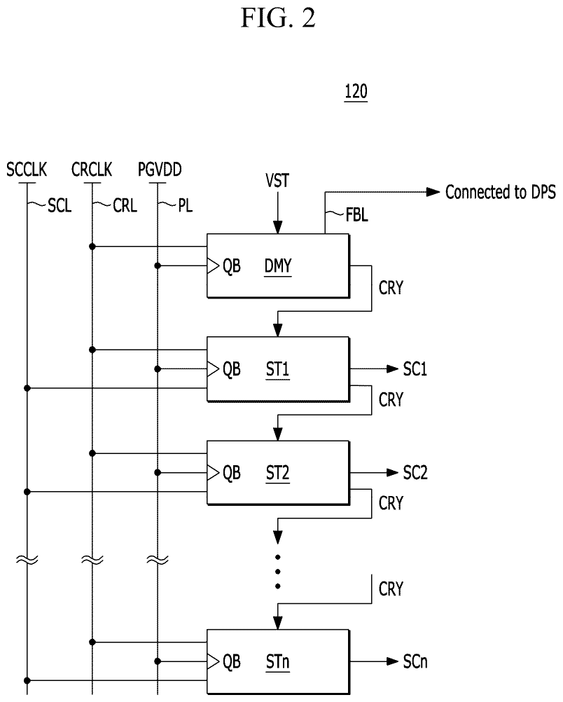

FIG. 2 is a diagram schematically illustrating a stage connection configuration of a gate driver 120 according to an example embodiment.

As shown in FIG. 2, the gate driver 120 may include a plurality of gate stages ST1 to STn and one dummy stage DMY, which are formed by the same TFT process as a display panel. Output nodes of the gate stages ST1 to STn may be connected to gate lines of the display panel, and an output node of the dummy stage DMY may not be connected to the gate lines of the display panel.

The gate stages ST1 to STn and the dummy stage DMY may be connected to a high-level power line PL and may receive a high-level variable voltage PGVDD through the high-level power line PL.

The gate stages ST1 to STn and the dummy stage DMY may be connected to a carry clock line CRL and may receive, through a carry clock line CRL, a carry clock CRCLK where a voltage of an on clock varies.

The gate stages gate stages ST1 to STn may be connected to a scan clock line SCL and may receive, through the scan clock line SCL, a scan clock SCCLK where a voltage of an on clock is fixed to a gate high voltage. Also, because the dummy stage DMY does not generate a gate signal for panel driving, the dummy stage DMY may not need to receive the scan clock SCCLK.

The dummy stage DMY may activate an operation of a Q node to output the carry signal CRY, based on a gate start signal VST included in the timing control signal GDC described above. The dummy stage DMY may be connected to the driving power control circuit DPS through a feedback line FBL. The driving power control circuit DPS may control an output of a high-level variable voltage, based on a monitoring current flowing in the feedback line FBL. The dummy stage DMY may be disposed at an uppermost end of each of the gate stages ST1 to STn, and/or may be disposed at a lowermost end of each of the gate stages ST1 to STn.

Based on the carry signal CRY input from a previous stage, the gate stages ST1 to STn may activate an operation of the Q node to generate gate signals SC1 to SCn and may supply the gate signals SC1 to SCn to the gate lines of the display panel.

Each of the gate stages ST1 to STn may include a Q node and a QB node, which operates to be opposite to each other. When the Q node is activated, the QB node may be deactivated, and when the QB node is activated, the Q node may be deactivated. In other words, when a voltage of the Q node is activated to an on level, a voltage of the QB node is deactivated to an off level, and conversely, when the voltage of the QB node is activated to the on level, the voltage of the Q node is deactivated to the off level.

In one frame period, a period where the QB node is activated to the high-level variable voltage PGVDD may be far longer than a period where the Q node is activated. Therefore, the amount of degradation of a pull-down transistor including a gate electrode connected to the QB node may be greater than the amount of degradation of a pull-up transistor including a gate electrode connected to the Q node. When the pull-down transistor is degraded, the gate signals SC1 to SCn output from the gate stages ST1 to STn may be distorted, and thus, it may be difficult to normally secure a data charge timing in a pixel.

To decrease a degradation of the pull-down transistor, it may be preferable that an initial setting value of the high-level variable voltage PGVDD applied to QB nodes of the gate stages ST1 to STn in common is set to be low within a predetermined target voltage range.

An on clock voltage of the carry clock CRCLK may be set to be low in initial driving, and then, may be up-controlled based on degradation progress (or temperature increase). In a case where the on clock voltage of the carry clock CRCLK is driven to be low in initial driving, even when threshold voltages of some transistors are (−) shifted in initial driving, an adverse effect of an abnormal ripple voltage applied to the Q node may be reduced. An adverse effect of a ripple voltage caused by the (−) shift of a threshold voltage may decrease, and thus, a risk of an abnormal screen occurring in initial reliability driving of a gate driver may be reduced.

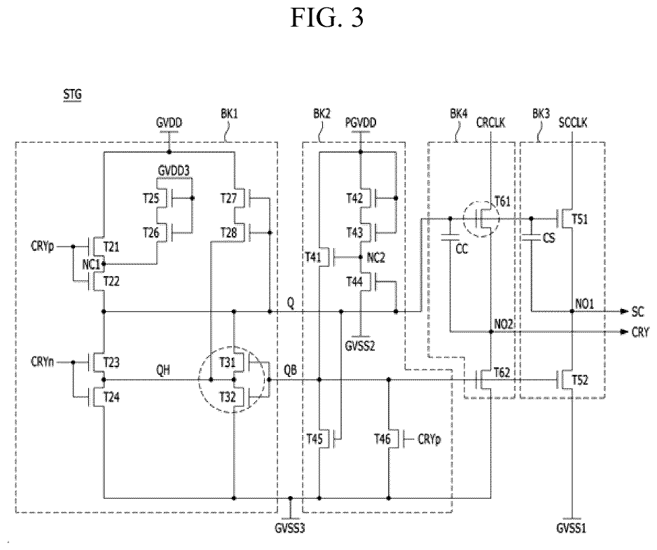

FIG. 3 is a diagram illustrating a circuit configuration of a stage included in a gate driver according to an example embodiment.

As shown in FIG. 3, a stage circuit STG may include a Q node, a QH node, and a QB node. The stage circuit STG may include a Q/QH node controller BK1, a QB node controller BK2, a scan output unit BK3, and a carry output unit BK4.

The Q/QH node controller BK1 may charge the Q node at a first high-level voltage GVDD level in response to a previous carry signal CRYp and may discharge the Q node at a third low-level voltage GVSS3 level in response to a next carry signal CRYn. To this end, the Q/QH node controller BK1 may include first to eighth transistors T21 to T28.

The first transistor T21 and the second transistor T22 may be connected between an input of the first high-level voltage GVDD and the Q node. The first transistor T21 and the second transistor T22 may be serially connected to each other. The first transistor T21 and the second transistor T22 may charge the Q node at the first high-level voltage GVDD level of a fixed level in response to the previous carry signal CRYp. The first transistor T21 may be turned on based on an input of the previous carry signal CRYp and may supply the first high-level voltage GVDD to a first connection node NC1. The second transistor T22 may be turned on based on an input of the previous carry signal CRYp and may electrically connect a connection node NC2 to the Q node. Accordingly, when the first transistor T21 and the second transistor T22 are simultaneously turned on, the first high-level voltage GVDD may be supplied to the Q node.

The fifth transistor T25 and the sixth transistor T26 may be connected to an input of the third high-level voltage GVDD3. The fifth transistor T25 and the sixth transistor T26 may supply the third high-level voltage GVDD3 to the connection node NC2 in response to the third high-level voltage GVDD3. The fifth transistor T25 and the sixth transistor T26 may be simultaneously turned on by the third high-level voltage GVDD3 and may continuously supply the third high-level voltage GVDD3 of a fixed level to the first connection node NC1, and thus, may increase a voltage difference between a gate voltage of the first transistor T21 and a voltage of the first connection node NC1. Therefore, when the first transistor T21 is turned off as the previous carry signal CRYp of an off level is input to a gate of the first transistor T21, the first transistor T21 may be maintained in a complete turn-off state due to the voltage difference between the gate voltage of the first transistor T21 and the voltage of the first connection node NC1. As a result, a current leakage of the first transistor T21 and the voltage drop of the Q node caused thereby may be prevented or reduced, and thus, a voltage of the Q node may be more stably maintained. To this end, the third high-level voltage GVDD3 may be set to a voltage level which is lower than the first high-level voltage GVDD.

The third transistor T23 and the fourth transistor T24 may be connected between an input of a third low-level voltage GVSS3 and the Q node. The third transistor T23 and the fourth transistor T24 may be serially connected to each other. The third transistor T23 and the fourth transistor T24 may discharge the Q node and the QH node to the third low-level voltage GVSS3 level in response to the next carry signal CRYn. The fourth transistor T24 may be turned on based on the next carry signal CRYn and may discharge the QH node to a second low-level voltage GVSS2 level. The third transistor T23 may be turned on based on the next carry signal CRYn and may electrically connect the Q node to the QH node. When the third transistor T23 and the fourth transistor T24 are simultaneously turned on, each of the Q node and the QH node may be discharged to the third low-level voltage GVSS3 level.

The seventh transistor T27 and the eighth transistor T28 may be connected between an input of the first high-level voltage GVDD and the Q node and between the input of the first high-level voltage GVDD and the QH node. The seventh transistor T27 and the eighth transistor T28 may be serially connected to each other. The seventh transistor T27 and the eighth transistor T28 may supply the first high-level voltage GVDD to the QH node in response to a voltage of the Q node. The seventh transistor T27 may be turned on based on a voltage of the Q node of an on level and may supply the first high-level voltage GVDD to a shared node of the seventh transistor T27 and the eighth transistor T28. When the voltage of the Q node has an on level, the eighth transistor T28 may be turned on and may electrically connect the shared node to the QH node. Therefore, when the voltage of the Q node has an on level, the seventh transistor T27 and the eighth transistor T28 may be simultaneously turned on and may supply the first high-level voltage GVDD to the QH node. When the first high-level voltage GVDD is supplied to the QH node, a voltage difference between a gate of the third transistor T23 and the QH node may increase. Accordingly, when the third transistor T23 is turned off as the next carry signal CRYn of an off level is input to the gate of the third transistor T23, the third transistor T23 may be maintained in a complete turn-off state due to the voltage difference between the gate voltage of the third transistor T23 and a voltage of the QH node. As a result, a current leakage of the third transistor T23 and the voltage drop of the Q node caused thereby may be prevented or reduced, and thus, a voltage of the Q node may be more stably maintained.

The Q/QH node controller BK1 may discharge the Q node and the QH node to the third low-level voltage GVSS3 level in response to a voltage of the QH node. To this end, the Q/QH node controller BK1 may further include a first additional transistor T31 and a second additional transistor T32. The first additional transistor T31 and the second additional transistor T32 may be connected between the Q node and an input of the third low-level voltage GVSS3. The first additional transistor T31 and the second additional transistor T32 may be serially connected to each other. The first additional transistor T31 and the second additional transistor T32 may discharge the Q node and the QH node to the third low-level voltage GVSS3 level in response to the voltage of the QB node. When the voltage of the QB node has an on level, the second additional transistor T32 may be turned on and may supply the third low-level voltage GVSS3 to a shared node of the first additional transistor T31 and the second additional transistor T32. When the voltage of the QB node has an on level, the first additional transistor T31 may electrically connect the Q node to the QH node. As a result, when the first additional transistor T31 and the second additional transistor T32 are simultaneously turned on in response to the voltage of the QB node, each of the Q node and the QH node may be discharged to the third low-level voltage GVSS3 level.

The QB node controller BK2 may shift a voltage level of the QB node, based on a voltage level of the Q node. To this end, the QB node controller BK2 may include first to third transistors T41 to T45.

The second transistor T42 and the third transistor T43 may be connected between an input of the high-level variable voltage PGVDD and the second connection node NC2. The second transistor T42 and the third transistor T43 may be serially connected to each other. The second transistor T42 and the third transistor T43 may supply the high-level variable voltage PGVDD to the connection node NC3 in response to the high-level variable voltage PGVDD. The second transistor T42 may be turned on based on the high-level variable voltage PGVDD and may supply the high-level variable voltage PGVDD to a shared node of the second transistor T42 and the third transistor T43. The third transistor T43 may be turned on based on the high-level variable voltage PGVDD and may electrically connect the connection node NC3 to the shared node of the second transistor T42 and the third transistor T43. When the second transistor T42 and the third transistor T43 are simultaneously turned on by the high-level variable voltage PGVDD, the connection node NC3 may be charged at the high-level variable voltage PGVDD level. The fourth transistor T44 may be connected between the connection node NC3 and a second low-level voltage line transferring the second low-level voltage GVSS2. The fourth transistor T44 may supply the second low-level voltage GVSS2 to the connection node NC3 in response to the voltage of the Q node. When the voltage of the Q node has an on level, the fourth transistor T44 may discharge or reset the second connection node NC2 to the second low-level voltage GVSS2.

The first transistor T41 may be connected between the input of the high-level variable voltage PGVDD and the QB node. The first transistor T41 may supply the high-level variable voltage PGVDD to the QB node in response to a voltage of the connection node NC3. When the voltage of the connection node NC3 has an on level, the first transistor T41 may be turned on and may charge the QB node at the high-level variable voltage PGVDD level. The fifth transistor T45 may be connected between the QB node and an input of the third low-level voltage GVSS3. The fifth transistor T45 may supply the third low-level voltage GVSS3 to the QB node in response to the voltage of the Q node. When the voltage of the Q node has an on level, the fifth transistor T45 may be turned on and may discharge the QB node to the third low-level voltage GVSS3 level.

The QB node controller BK2 may discharge the QB node to the third low-level voltage GVSS3 level in response to an input of a next carry signal C(k-2). To this end, the QB node controller BK2 may further include a first additional transistor T51.

The first additional transistor T51 may be connected between the QB node and an input of the third low-level voltage GVSS3. The first additional transistor T51 may supply the third low-level voltage GVSS3 to the QB node in response to an input of the previous carry signal CRYp.

The scan output unit BK3 may output an on-clock voltage of a scan clock SCCLK as a scan signal SC of an on voltage while the Q node is being charged at an on voltage level and may output the first low-level voltage GVSS1 as the scan signal SC of an off voltage while the QB node is being charged at an on voltage level. To this end, the scan output unit BK3 may include a first pull-up transistor T51, a first pull-down transistor T52, and a first boosting capacitor CS.

The first pull-up transistor T51 may be connected between the input of the scan clock SCCLK and a first output node NO1. The first boosting capacitor CS may be connected between a gate and a source of the first pull-up transistor T51. When the scan clock SCCLK of a gate on voltage is output to the first output node NO1, the first boosting capacitor CS may bootstrap the voltage of the Q node up to a boosting voltage level which is higher than the first high-level voltage GVDD, in synchronization with the scan clock SCCLK of a gate on voltage. When the voltage of the Q node is bootstrapped, the scan signal SC of an on voltage may be quickly charged in the first output node NO1 without distortion. Accordingly, the scan signal SC of an on voltage may be output from the first output node NO1.

The first pull-down transistor T52 may be connected between the first output node NO1 and an input of the first low-level voltage GVSS1. The first pull-down transistor T52 may be turned on based on a voltage of the QB node of an on voltage level. Accordingly, the first low-level voltage GVSS1 (i.e., the scan signal SC of an on voltage) may be output from the first output node NO1.

The carry output unit BK4 may output the carry clock CRCLK of a variable on clock voltage as the carry signal CRY of an on voltage while the Q node is being charged at an on voltage level and may output the third low-level voltage GVSS3 as the carry signal CRY of an off voltage while the QB node is being charged at an on voltage level.

The carry output unit BK4 may include a second pull-up transistor T61, a second pull-down transistor T62, and a second boosting capacitor CC. The second pull-up transistor T61 may be connected between an input of the carry clock CRCLK and a second output node NO2. The second boosting capacitor CC may be connected between a gate and a source of the second pull-up transistor T61. When the carry clock CRCLK of a variable on clock voltage is output to the second output node NO2, the second boosting capacitor CC may bootstrap the voltage of the Q node up to the boosting voltage level which is higher than the first high-level voltage GVDD, in synchronization with the carry clock CRCLK. When the voltage of the Q node is bootstrapped, the carry signal CRY of a variable on voltage may be quickly charged in the second output node NO2 without distortion. Accordingly, the carry signal CRY of a variable on voltage may be output from the second output node NO2. Therefore, the carry signal CRY of a variable on voltage may be output from the second output node NO2. The second pull-down transistor T62 may supply the third low-level voltage GVSS3 to the output node NO in response to the voltage of the QB node of an on level. Accordingly, the carry signal CRY of an off voltage may be output from the second output node NO2.

In the present embodiment, the first low-level voltage GVSS1 may be set to −6 V, the second low-level voltage GVSS2 may be set to −10 V, and the third low-level voltage GVSS3 may be set to −12 V, so that the voltages of the Q node, the QB node, and the QH node are stabilized by minimizing an off current flowing in transistors of an off state. In other embodiments, the first low-level voltage GVSS1 and the second low-level voltage GVSS2 may also be set to the same voltage (for example, −6 V). However, such voltage values may be merely an embodiment, and a level of a low-level voltage may be changed based on a design spec.

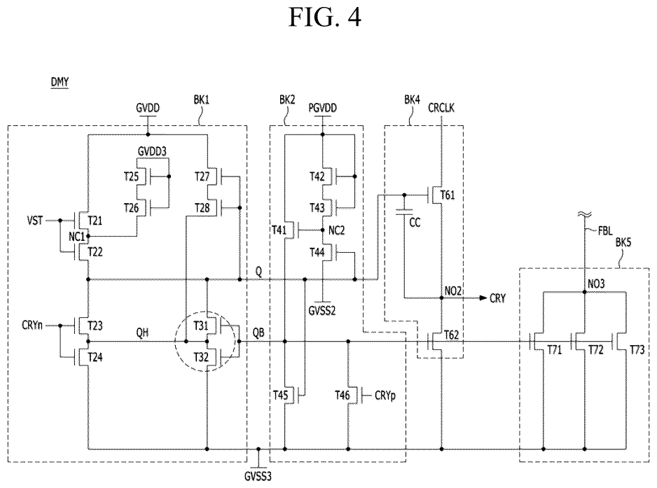

FIG. 4 is a diagram illustrating a circuit configuration of a dummy stage included in a gate driver according to an example embodiment.

As shown in FIG. 4, a dummy stage circuit DMY may include a Q node, a QB node, and a QH node. The dummy stage circuit DMY may include a Q/QH node controller BK1, a QB node controller BK2, a carry output unit BK4, and a sensing unit BK5.

The Q/QH node controller BK1, the QB node controller BK2, and the carry output unit BK4 may be substantially the same as the elements of the stage circuit STG of FIG. 3. However, the dummy stage circuit DMY may have a difference with the stage circuit STG of FIG. 3 in that a gate start signal VST instead of a previous carry signal CRYp is applied to the Q/QH node controller BK1.

The sensing unit BK5 may include one or more monitoring transistors T71, T72, and T73. Gate electrodes of the monitoring transistors T71, T72, and T73 may be connected to the QB node, drain electrodes thereof may be connected to a feedback line FBL through a sensing node NO3, and source electrodes thereof may be connected to an input of a first low-level voltage GVSS1.

A monitoring current may flow in the monitoring transistors T71, T72, and T73 while the QB node is being activated. A driving power control circuit DPS may be connected to the sensing node NO3 of the sensing unit BK5 through the feedback line FBL. The driving power control circuit DPS may increase an output of a high-level variable voltage, based on the monitoring current flowing in the feedback line FBL, and thus, may prevent or reduce an abnormal operation caused by a degradation in transistors each including a gate electrode connected to the QB node.

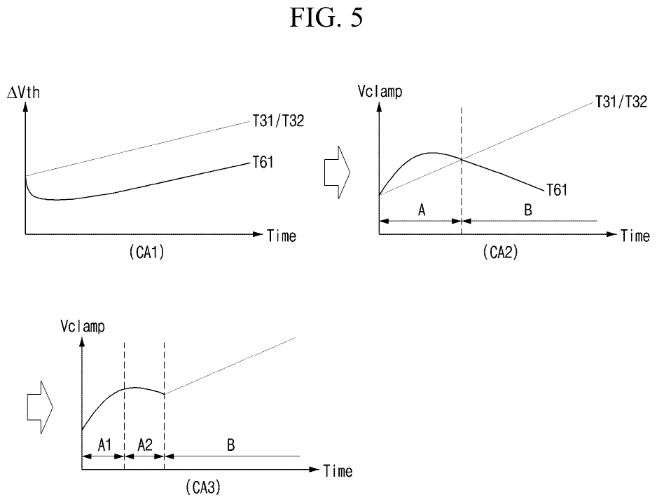

FIG. 5 is a diagram illustrating an abnormal behavior of Vclamp with respect to a threshold voltage shift characteristic of transistors included in a stage.

As shown in FIGS. 3 and 5, transistors included in a stage may each be implemented as an oxide transistor. After being initially manufactured, a threshold voltage (Vth) distribution of the transistors may appear up to a (+) section from a (−) section.

As in FIG. 5 (CA1), in initial driving, a possibility that a threshold voltage (Vth) of a transistor T61 is (−) shifted may be high, unlike a threshold voltage (Vth) of a transistor T31/T32. In this case, a threshold voltage variation (ΔVth) of the transistor T61 may down-move in initial driving, and then, may up-move as a driving time elapses, thereby drawing a “nike” curve.

As in FIG. 5 (CA2) and (CA3), in A and B sections, a screen defect prevention voltage Vclamp caused by a (+) Vth shift behavior of the transistor T31/T32 may increase.

On the other hand, in an A1 section, a leakage current of the transistor T61 may increase due to a (−) Vth shift behavior of the transistor T61, and due to this, an abnormal fine carry output may occur. A fine carry output may flow into a Q node, causing a ripple of a Q node voltage. Therefore, the screen defect prevention voltage Vclamp caused by a (−) Vth shift behavior of the transistor T61 may rapidly increase, and then, may decrease in the A2 section. When the screen defect prevention voltage Vclamp is higher than a high-level variable voltage PGVDD in the A1 section, an abnormal image may occur.

As described above, as a carry clock CRCLK signal is leaked to the inside (i.e., a Q node) of a stage circuit in a section A1 where Vth of the transistor T61 down-moves, a screen defect possibility may increase. To decrease a screen defect possibility, a leakage current flowing in the transistor T61 should be reduced.

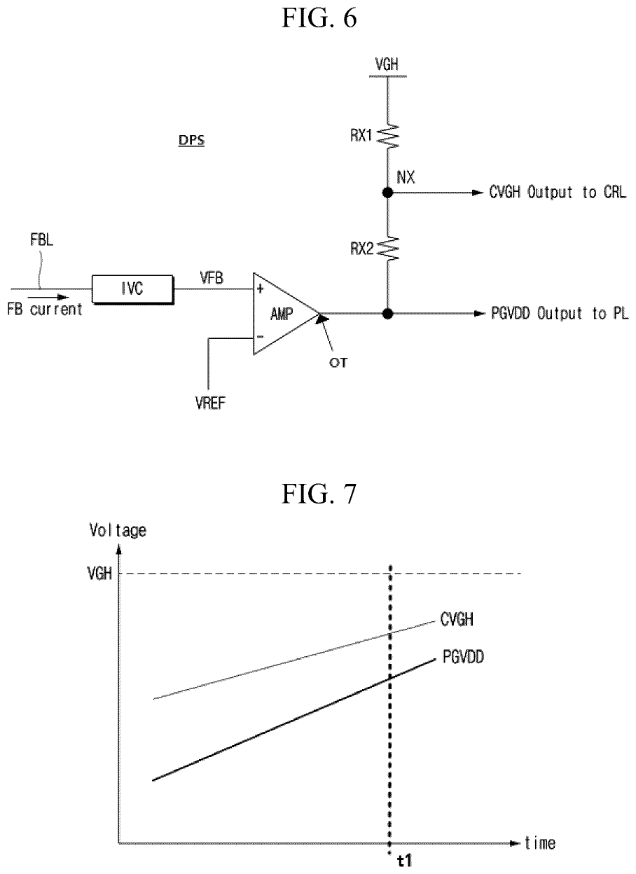

FIG. 6 is a diagram illustrating a driving power control circuit according to an example embodiment.

As shown in FIG. 6, a driving power control circuit DPS may set a high-level variable voltage PGVDD, which is to be applied to a QB node of each stage, to be low, and then, may progressively increase as a driving time elapses, thereby preventing or reducing an abnormal operation caused by a degradation in transistors each including a gate electrode connected to the QB node.

The driving power control circuit DPS may set an on-clock voltage CVGH of a carry clock to be low in initial driving, and thus, may decrease the amount of leakage current in a transistor T61 even when there is (−) Vth shift behavior of the transistor T61 in the A1 section. Also, the driving power control circuit DPS may progressively increase the on-clock voltage CVGH of the carry clock as a driving time elapses, and thus, may prevent or reduce an abnormal operation caused by a degradation in the transistor T61.

The driving power control circuit DPS may progressively increase the high-level variable voltage PGVDD and the on-clock voltage CVGH of the carry clock within a voltage range which is lower than a gate high voltage VGH which is an on clock voltage of a scan clock, thereby reducing power consumption.

The driving power control circuit DPS may receive the monitoring current fed back from a dummy stage through the feedback line FBL and may supply the high-level variable voltage PGVDD, up-controlled based on a feedback current, to gate stages and the dummy stage through the power line PL.

The driving power control circuit DPS may increase the on-clock voltage CVGH of the carry clock in association with an output of the high-level variable voltage PGVDD, and then, may supply the up-controlled on clock voltage CVGH of the carry clock to the gate stages and the dummy stage through a clock line.

The driving power control circuit DPS may include a current-voltage conversion circuit IVC, an amplifier circuit AMP, and voltage division resistors (for example, first and second voltage division resistors) RX1 and RX2.

The current-voltage conversion circuit IVC may be connected to the dummy stage through the feedback line FBL. The current-voltage conversion circuit IVC may receive, as the feedback current, the monitoring current flowing in the dummy stage and may convert the feedback current into a feedback voltage VFB. The current-voltage conversion circuit IVC may be implemented as a current integrator, but is not limited thereto.

The amplifier circuit AMP may include a first input terminal (+) through which the feedback voltage VFB is input, a second input terminal (−) through which a predetermined reference voltage VREF is input, and an output terminal OT. As a driving time elapses, the feedback voltage VFB may increase. The amplifier circuit AMP may up-control the high-level variable voltage PGVDD at the output terminal OT so that the feedback voltage VFB is equal to the reference voltage VREF.

The first voltage division resistor RX1 and the second voltage division resistor RX2 may be serially connected to each other through a voltage division node NX, between a gate high voltage VGH of a fixed level and the output terminal OT of the amplifier circuit, and the on-clock voltage CVGH of the carry clock may be up-controlled in the voltage division node NX and may be supplied to a clock line CRL. The on-clock voltage CVGH of the carry clock may be “(VGH−PGVDD)*{RX2/(RX1+RX2)}”. As a result, the on-clock voltage CVGH of the carry clock may be associated with the high-level variable voltage PGVDD.

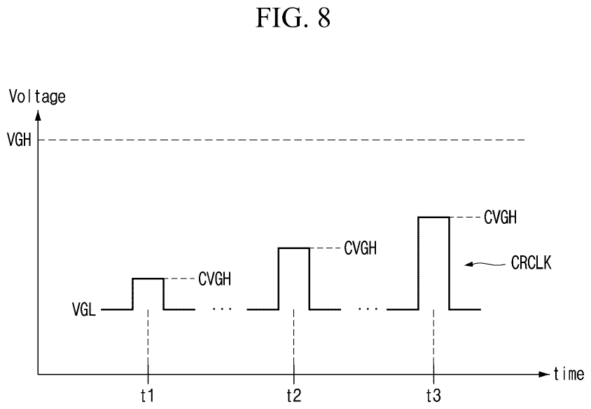

FIG. 7 is a diagram illustrating an output of a driving power control circuit according to an example embodiment. FIG. 8 is a diagram illustrating an example where an on-clock voltage of a carry clock is up-shifted as a driving time elapses, within a voltage range which is lower than a gate high voltage.

As shown in FIG. 7, at the same timing t1, a gate high voltage VGH may higher than an up-controlled on clock voltage CVGH of a carry clock, which is higher than an up-controlled high-level variable voltage PGVDD.

As shown in FIG. 8, an on-clock voltage CVGH of a carry clock CRCLK may increase as a driving time elapses to t1, t2, and t3, within a gate high voltage VGH. Also, an off-clock voltage of the carry clock CRCLK may be fixed to a gate low voltage VGL regardless of elapsing of the driving time.

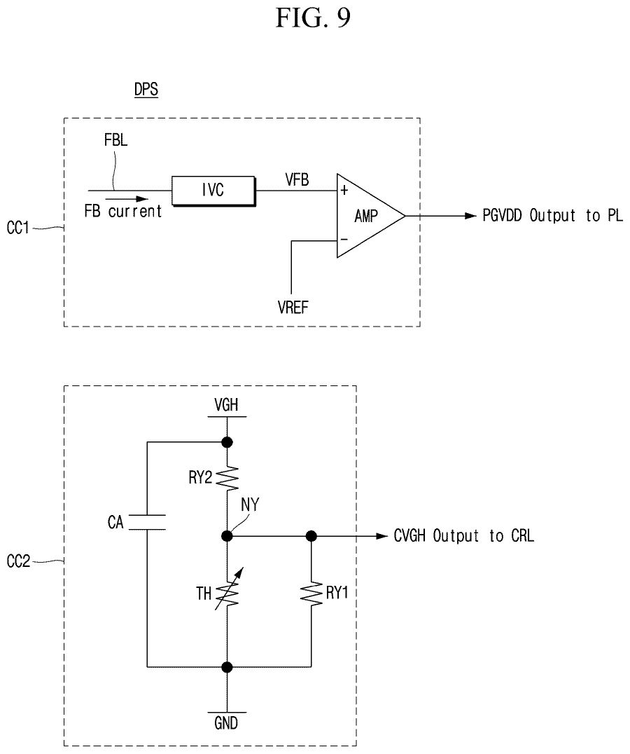

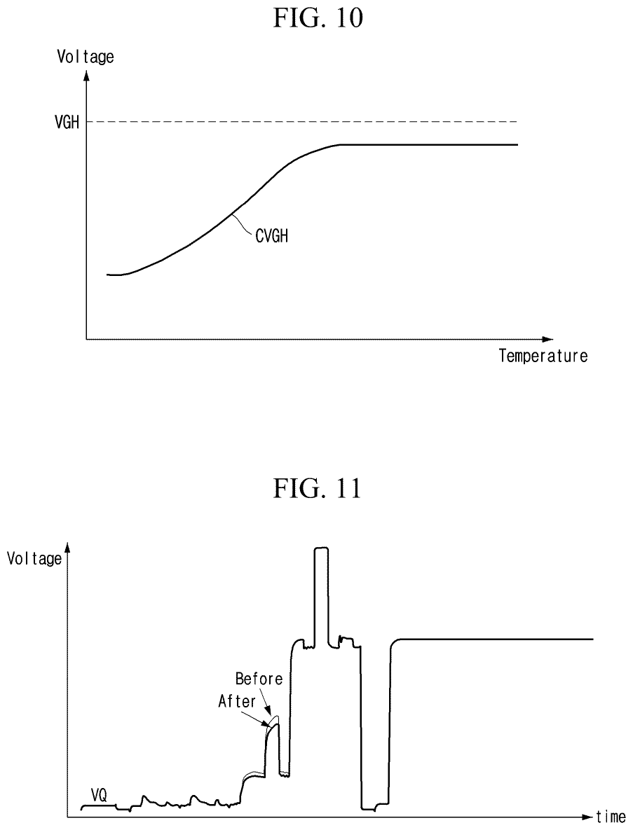

FIG. 9 is a diagram illustrating a driving power control circuit according to another example embodiment. FIG. 10 is a diagram illustrating an output of a driving power control circuit according to another example embodiment.

As shown in FIG. 9, a driving power control circuit DPS may include a first control circuit CC1 which controls a high-level variable voltage PGVDD and a second control circuit CC2 which controls an on-clock voltage CVGH of a carry clock regardless of the first control circuit CC1.

The first control circuit CC1 may receive a monitoring current fed back from a dummy stage through a feedback line FBL and may supply the high-level variable voltage PGVDD, up-controlled based on a feedback current, to gate stages and the dummy stage through a power line PL. The first control circuit CC1 may include a current-voltage conversion circuit IVC and an amplifier circuit AMP. The current-voltage conversion circuit IVC and the amplifier circuit AMP may be substantially the same as FIG. 6.

The second control circuit CC2 may up-control the on-clock voltage CVGH of the carry clock, based on a thermistor TH where a resistance value varies based on a temperature, and then, may supply the up-controlled on clock voltage CVGH of the carry clock to the gate stages and the dummy stage through a clock line CRL.

The second control circuit CC2 may include a voltage division node NY through which the on clock voltage CVGH of the carry clock up-controlled in proportion to a temperature is output, a thermistor TH and a first voltage division resistor RY1 connected to each other in parallel between the voltage division node NY and a ground voltage GND, a second voltage division resistor RY2 connected between a gate high voltage VGH of a fixed level and the voltage division node NY, and a capacitor CA connected between the gate high voltage VGH and the ground voltage GND.

In the second control circuit CC2, TH may represent a thermistor, CA may represent a bypass capacitor, RY2 may represent a resistor for voltage division, and RY1 may represent a resistor for reducing a variation width based on a temperature of the thermistor (RY1>>RY2).

The thermistor TH may be a PTC-type thermistor which has a low resistance value toward a low temperature and has a high resistance value toward a high temperature. When a temperature is low, a resistance value of the thermistor TH may be relatively lowered. In a case which configures a circuit by using a characteristic of the thermistor TH, the gate high voltage VGH may be divided by two resistors RY1 and RY2 and a parallel resistance value of the thermistor TH, and thus, as expressed in the following Equation 1, a division voltage may be the on-clock voltage CVGH of the carry clock.

$$CVGH = VGH * [ ( R 1 // TH ) / \{ R 2 + ( R 1 // TH ) \} ] \qquad [ Equation 1 ]$$

As a result, in initial driving, when a temperature decreases, the on-clock voltage CVGH of the carry clock may be reduced, and thus, a leakage current flowing in the transistor T61 of FIG. 3 may decrease, and moreover, when a temperature increases, the on-clock voltage CVGH of the carry clock may increase, and thus, a characteristic similar to a room temperature may be maintained. In other words, a characteristic corresponding to a temperature may be compensated for.

Accordingly, as in FIG. 10, based on a thermistor TH where a resistance value varies based on a temperature, the on-clock voltage CVGH of the carry clock may be lower in a low temperature environment of initial driving than a high temperature environment after a driving time elapses.

Moreover, the on-clock voltage CVGH of the carry clock may be saturated to a division voltage which is lower than a gate high voltage of a fixed level, in a high temperature environment after a driving time elapses.

As shown in FIG. 11, as described above, the on-clock voltage of the carry clock may be set to be lower in a low temperature environment of initial driving than a high temperature environment after a driving time elapses, and thus, a ripple magnitude of a Q node voltage may decrease.

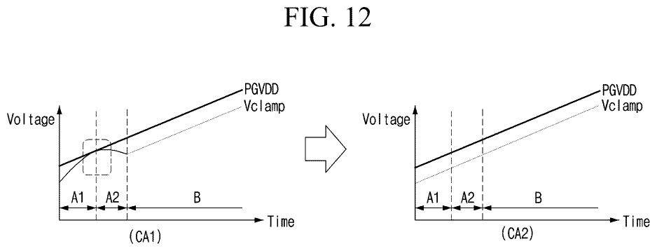

As shown in FIG. 12 (CA1), when a screen defect prevention voltage Vclamp is higher than a high-level variable voltage PGVDD in an A1 section, an abnormal image may occur.

On the other hand, as in FIG. 12 (CA2), in a case where an on-clock voltage CVGH of a carry clock is set to be low, even when a threshold voltage is shifted in an A1 section, there may be an effect where an abnormal behavior of a screen defect prevention voltage Vclamp is prevented.

Example embodiments of the present disclosure may realize the following example effects.

In example embodiments of the present disclosure, an on-clock voltage of a carry clock may be set to be lower in a low temperature environment of initial driving than a degradation (or high temperature) environment after a driving time elapses, and thus, a ripple magnitude of a Q node voltage may decrease. As a result, an adverse effect of a ripple voltage caused by the (−) shift of a threshold voltage may decrease, and thus, a risk of an abnormal screen occurring in initial reliability driving of a gate driver may be reduced.

The effects according to the present disclosure are not limited to the above examples, and other various effects may be included or achieved by the practice of the present disclosure.

While the present disclosure has been particularly shown and described with reference to various example embodiments thereof, it will be understood by those of ordinary skill in the art that various changes in form and details may be made therein without departing from the spirit and scope of the present disclosure as defined by the following claims and their equivalents.

What is claimed is:

1. A display apparatus, comprising:
a display panel;
a gate driver configured to receive a high-level variable voltage and a carry clock for an operation of each stage to drive gate lines of the display panel; and
a driving power control circuit configured to control an on-clock voltage of the carry clock and the high-level variable voltage configured to be applied to a QB node of each stage,
wherein the high-level variable voltage and the on-clock voltage of the carry clock are configured to be up-shifted as a driving time elapses.

2. The display apparatus of claim 1, wherein:
the gate driver is further configured to receive a scan clock for the operation of each stage;
an on-clock voltage of the scan clock is a gate high voltage of a fixed level; and
the high-level variable voltage and the on-clock voltage of the carry clock are up-shifted within a voltage range which is lower than the gate high voltage, as the driving time elapses.

3. The display apparatus of claim 1, wherein:
the gate driver comprises a plurality of gate stages and a dummy stage;
the driving power control circuit is further configured to receive a monitoring current fed back from the dummy stage through a feedback line and to supply a high-level variable voltage, up-controlled based on a feedback current, to the gate stages and the dummy stage through a power line; and
the driving power control circuit is further configured to increase the on-clock voltage of the carry clock in association with an output of the high-level variable voltage and to supply an up-controlled on-clock voltage of the carry clock to the gate stages and the dummy stage through a clock line.

4. The display apparatus of claim 3, wherein:
the dummy stage comprises at least one monitoring transistor including a gate electrode connected to the QB node, a first electrode connected to the feedback line, and a second electrode connected to a low-level voltage; and
the monitoring current is configured to flow in the at least one monitoring transistor while a voltage of the QB node is at an on level.

5. The display apparatus of claim 3, wherein the driving power control circuit comprises:
a current-voltage conversion circuit configured to convert the feedback current into a feedback voltage;
an amplifier circuit including a first input terminal configured to receive the feedback voltage, a second input terminal configured to receive a predetermined reference voltage, and an output terminal, the amplifier circuit being configured to up-control the high-level variable voltage at the output terminal so that the feedback voltage is equal to the predetermined reference voltage; and
a first voltage division resistor and a second voltage division resistor serially connected to each other through a voltage division node, between a gate high voltage of a fixed level and the output terminal of the amplifier circuit, and
wherein the on-clock voltage of the carry clock is configured to be up-controlled in the voltage division node and be supplied to the clock line.

6. The display apparatus of claim 5, wherein, at a same timing during the driving time, the gate high voltage is higher than the up-controlled on-clock voltage of the carry clock which is higher than the up-controlled high-level variable voltage.

7. The display apparatus of claim 1, wherein:
the gate driver comprises a plurality of gate stages and one dummy stage; and
the driving power control circuit comprises:
a first control circuit configured to receive a monitoring current fed back from the dummy stage through a feedback line and to supply a high-level variable voltage, up-controlled based on a feedback current, to the gate stages and the dummy stage through a power line; and
a second control circuit configured to up-control the on-clock voltage of the carry clock, based on a thermistor where a resistance value varies based on a temperature, and to supply the up-controlled on-clock voltage of the carry clock to the gate stages and the dummy stage through a clock line.

8. The display apparatus of claim 7, wherein:
the first control circuit comprises:
a current-voltage conversion circuit configured to convert the feedback current into a feedback voltage; and
an amplifier circuit including a first input terminal configured to receive the feedback voltage, a second input terminal configured to receive a predetermined reference voltage, and an output terminal, the amplifier circuit being configured to up-control the high-level variable voltage at the output terminal so that the feedback voltage is equal to the predetermined reference voltage; and
the second control circuit comprises:
a voltage division node through which the on-clock voltage of the carry clock up-controlled in proportion to the temperature is output;
the thermistor and a first voltage division resistor connected to each other in parallel between the voltage division node and a ground voltage;
a second voltage division resistor connected between a gate high voltage of a fixed level and the voltage division node; and
a capacitor connected between the gate high voltage and the ground voltage.

9. The display apparatus of claim 8, wherein the on-clock voltage of the carry clock is lower in a low temperature environment of initial driving than in a high temperature environment after the driving time elapses from the initial driving, based on a thermistor where a resistance value varies based on a temperature.

10. The display apparatus of claim 9, wherein the on-clock voltage of the carry clock is saturated to a division voltage which is lower than a gate high voltage of a fixed level, in the high temperature environment after the driving time elapses from the initial driving.

11. A driving power control method of a display apparatus, the driving power control method comprising:
receiving a high-level variable voltage and a carry clock for an operation of each stage to drive gate lines of a display panel; and
controlling an on-clock voltage of the carry clock and the high-level variable voltage configured to be applied to a QB node of each stage,
wherein the high-level variable voltage and the on-clock voltage of the carry clock are configured to be up-shifted as a driving time elapses.

12. The driving power control method of claim 11, further comprising receiving a scan clock for the operation of each stage,
wherein an on-clock voltage of the scan clock is a gate high voltage of a fixed level, and
wherein the high-level variable voltage and the on-clock voltage of the carry clock are up-shifted within a voltage range which is lower than the gate high voltage, as the driving time elapses.

13. The driving power control method of claim 11, wherein the on-clock voltage of the carry clock is configured to be up-shifted in association with an output of the high-level variable voltage.

14. The driving power control method of claim 12, wherein, at a same timing during the driving time, the gate high voltage is higher than the up-shifted on-clock voltage of the carry clock which is higher than the up-shifted high-level variable voltage.

15. The driving power control method of claim 11, wherein the on-clock voltage of the carry clock is lower in a low temperature environment of initial driving than in a high temperature environment after the driving time elapses from the initial driving, based on a thermistor where a resistance value varies based on a temperature.

16. The driving power control method of claim 15, wherein the on-clock voltage of the carry clock is saturated to a division voltage which is lower than a gate high voltage of a fixed level, in the high temperature environment after the driving time elapses from the initial driving.
